(19) United States
(12) Patent Application Publication
(10) Pub. No.: US 2008/0003395 A1
(43) Pub. Date: Jan. 3, 2008

(54) DURABLE PREMIUM WOOD BOARDS AND PROCESS FOR PRODUCING THE SAME

(76) Inventors: Futong Cui, Charlotte, NC (US); Alan Preston, Charlotte, NC (US); Lehong Jin, Charlotte, NC (US); Paul Walcheski, Mt Ulla, NC (US); Andrew R. Zahora, Harrisburg, NC (US)

Correspondence Address: MCANDREWS HELD & MALLOY, LTD, 500 WEST MADISON STREET, SUITE 3400, CHICAGO, IL, 60661, US

(21) Appl. No.: 11/428,208

(22) Filed: Jun. 30, 2006

(51) Int. Cl. B32B 21/04; B32B 37/12; B32B 38/08; B32B 38/10

(52) U.S. Cl. 428/57; 428/537.1; 156/64; 156/304.1; 156/280

(57) ABSTRACT

One aspect of the invention is an engineered wood board. The wood board has a major face, and is made up of strips of wood which are oriented with the grain vertical relative to that major face. Additionally, the wood board contains an additive, which is present to improve the exterior durability of the wood. Another aspect of the invention is a method for manufacturing an engineered wood board that has a major face. The method includes the step of obtaining strips of wood that have a flat grain surface and a vertical grain surface. Those strips are assembled side by side, and are oriented with the vertical grain surfaces defining the major face of the board. Once the strips of wood are assembled, they are bonded together. At any stage in the method, a treatment is added to the wood to improve its water repellency and exterior durability.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This invention relates to engineered wood boards with increased effective dimensional stability. The invention also relates to methods of manufacturing engineered wood boards with increased effective dimensional stability, whereby strips of wood are assembled while oriented with the vertical grain surfaces defining a major face of the board. The wood strips or finished engineered wood board are treated so that the exterior durability is improved.

Wood is a renewable, strong, and enviromentally sound building material. Wood materials, however, have a number of drawbacks including poor dimensional stability and susceptibility to fungal attack and insect infestation. Wood treated with modern wood preservatives can have excellent decay and insect resistance. Physical performance of treated wood materials, especially when used outdoors, is less than ideal. Cracking, checking, warping, cupping, and twisting are some of the main problems of treated wood exposed to the weather.

Extensive research has been carried out in order to improve the dimensional stability of wood materials through chemical modifications. Common chemical processes for dimensional stabilization include cross-linking the wood with multi-functional molecules to form esters or ethers, and bulking the wood with hydrophilic polymers such as polyethylene glycol.

Other methods have also been claimed to provide certain degrees of dimensional stabilization. For example, wood can be treated with acrylic monomers and oligomers, that can then be polymerized in situ to offer dimensional stability and other benefits. Common resins such as phenol-formaldehyde, melamine-formaldehyde, urea-formaldehyde, or DMDHEU (dimethyloldihydroxyethylene urea) can also be introduced into the wood and cured in situ. A main drawback of chemical modification is the high cost. Chemically modified wood is used on a very small scale for specialty products. Another drawback is that problems associated with dimensional instability cannot be completely prevented in low quality boards such as those with large knots, pith, reaction wood, or juvenile wood.

The use of a water repellent is probably the most economical method of overcoming the problem of dimensional instability and reducing the checking and cracking of wood materials exposed to the weather. Water repellents, however, do not offer true dimensional stability. Water repellents only reduce the rate of moisture content change in wood materials. By doing so, the repellents reduce checking and cracking associated with moisture change but do not eliminate it.

Wood is an anisotropic material. Shrinkage and swelling is the most severe in the tangential direction of the log (the circumferential direction of the growth rings). In the radial direction of the log, the shrinkage and swelling is much less. As a result, quarter-sawn boards (vertical-grain) are desirable for exterior construction. Unfortunately, quarter-sawn boards are expensive and not readily available. Current construction grade lumber is mostly flat-sawn and contains defects such as large knots, wane, pith, and juvenile wood.

One way of converting common construction grade flat-sawn lumber into premium vertical-grain boards with minimal defects is to cut the flat-sawn boards length-wise into strips, rotate the strips by 90 degrees and edge-glue the strips into vertical-grain boards. Defects in the strips, such as knots and reaction wood, can be removed and the remaining strips of good wood can be joined by edge-gluing to form broader boards. Optionally, the wood strips can be extended, as by straight end gluing or finger-jointing, before edge-gluing them to form the final boards. These techniques are known in the prior art. For example, U.S. Pat. No. 5,050,653 describes a process of manufacturing laminated wood boards from waste offcuts. U.S. Pat. No. 5,135,597 discloses processes of manufacturing vertical-grain boards from flat-sawn boards by ripping and edge-gluing. U.S. Pat. No. 5,135,597 seems to stress the importance of virtually invisible glue lines and the preference of edge-gluing strips from the same original board. While value-added appearance grade boards can be manufactured based on processes described in U.S. Pat. No. 5,050,653 and U.S. Pat. No. 5,135,597, these boards are not adequate for exterior exposures such as decking, fencing, railing, and siding applications. When such edge-glued vertical-grain boards are exposed to weather, significant checking and cracking persist. In addition, the glue-line is not very durable even when an exterior glue that meets the ASTM D2559 standard is used.

### SUMMARY OF THE INVENTION

One aspect of the invention is an engineered wood board. The wood board has a major face, and is made up of strips of wood which are oriented with the grain vertical relative to that major face. A vertical grain means that with respect to the major surface of the board, the segments of the growth rings form an angle of more than 45 degrees. This orientation can be determined by observing the lesser included angle (i.e. the smaller of the two angles totaling 180 degrees) between the segments of the growth rings and the plane of a major face of the board, as by viewing the board from an end displaying end grain.

Additionally, the wood board can be treated to improve the exterior durability, water repellency, or both, of the wood.

Another aspect of the invention is a method for manufacturing an engineered wood board that has a major face. The method includes obtaining strips of wood that have a flat grain surface and a vertical grain surface. Those strips are oriented with the vertical grain surfaces defining a major face of the board. The strips then are assembled in that orientation and bonded together. At any stage in the method, a treatment is added to the wood to improve its exterior durability.

Optionally, the treatment described in the invention may be an additive, for example a wood preservative, such as alkaline copper quat, copper Azole, chromated copper arsenate, copper-HDO (a composition of copper oxide, boric acid, and Bis-(N-cyclohexyldiazeniumdioxycopper), borates, triazoles, isothiazalones, 3-iodo-2-propynyl butyl carbamate, or a combination of any of these wood preservatives.

### BRIEF DESCRIPTION OF THE DRAWINGS

FIG. 1 shows an engineered wood board of one aspect of the present invention.

FIG. 2 shows the engineered wood board of FIG. 1 viewed from an end displaying end grain.

FIG. 3 shows a sequence of certain steps relating to one aspect of the present invention and the product produced thereby.

FIG. 4 is a flow chart showing a sequence of process steps and the resulting products for another aspect of the present invention.

FIG. 5 shows a cross-sectional view of an engineered wood board of one aspect of the present invention.

FIG. 6 shows a cross-sectional view of an engineered wood board of one aspect of the present invention.

### DETAILED DESCRIPTION

While the invention will be described in connection with one or more embodiments, it will be understood that the invention is not limited to those embodiments. On the contrary, the invention includes all alternatives, modifications, and equivalents as may be included within the spirit and scope of the appended claims.

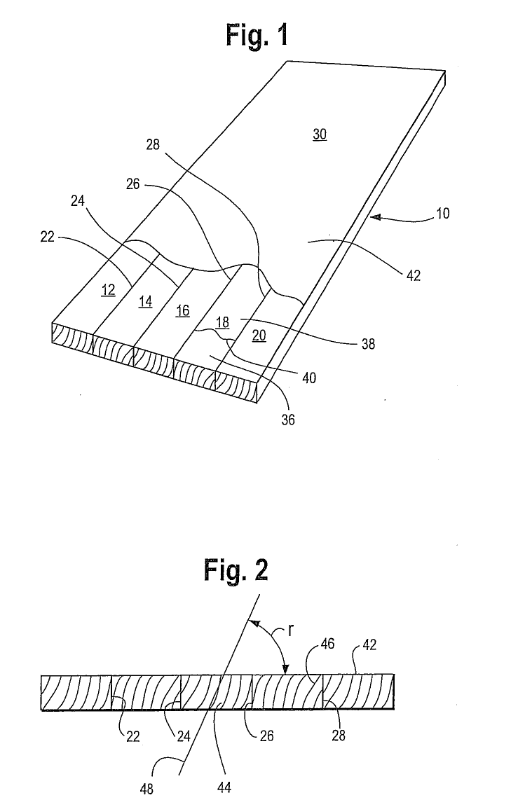

FIG. 1 shows an engineered wood board 10 that is illustrative of one aspect of the invention. The engineered board 10 can be made from any species or combination of species of wood. Optionally, the selected species or combination of species is suitable for exterior applications after carrying out the present process.

The engineered wood board 10 includes strips of wood such as 12, 14, 16, 18, and 20 bonded together by glue lines such as 22, 24, 26, and 28. Optionally, the board 10 can be coated at least partially, optionally fully, with a coating 30. While a conventional board with flat, parallel faces and straight edges is illustrated, this shape is merely representative of a variety of different shapes that can be used.

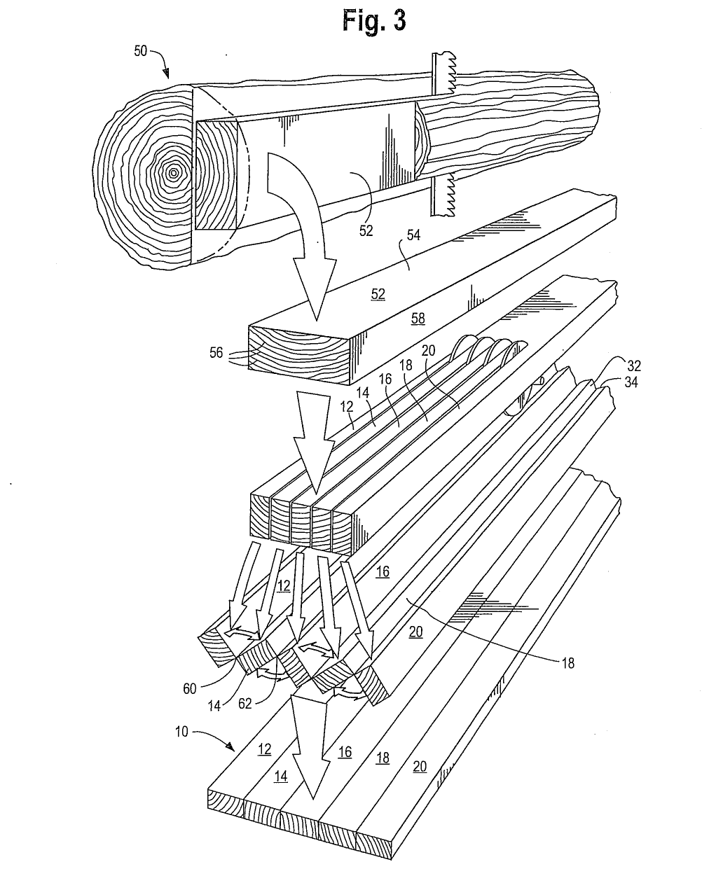

The strips of wood such as 12 may be of any size or shape. They optionally can be long strips with a fairly compact cross-section, as illustrated. Preferably, the surfaces such as 32 and 34 of the strips that are glued together (shown in FIG. 3) are complementary to provide a substantial area of contact between them.

Additionally, the strips of wood such as 18 may be comprised of two or more separate strips of wood such as 36 and 38 that have been joined end to end, as by being end glued or finger jointed at a joint 40, to make a strip of a desired length.

The strips of wood such as 12 are oriented with their grain vertical relative to a major face 42. A vertical grain means that at their intersection with the major surface 42 of the board, as shown in FIG. 2, the segments of the growth rings such as 44 and 46 in FIG. 2 form an angle r of more than 45 degrees, as shown by the index line 48 representing the angle of the growth ring 44 at its intersection with the major face 42. This orientation can be determined by observing the lesser included angle r between the segments of the growth rings and the plane of a major face of the board, as by viewing the board from an end displaying end grain, as shown in FIG. 2.

The finger jointing technique that may be used to end join boards in the present invention is well known in the art, and comprises first making corresponding zigzag or sawtooth cuts in the ends of the two boards that are to be joined. The finger joint in the resulting board shown can optionally be significantly obscured if the joined boards or strips have closely matched grain due to the use of a single board from which the individual boards are produced. The two sawtoothed ends are then joined, again by well-known, conventional gluing techniques to form a single board. Another example of an end joining technique is referred to as scarf joining which uses an angled cut and which may in some cases produce a less visible glue line.

The engineered wood board 10 is treated to improve the exterior durability of the wood. The treatment may alternatively be applied to the strips of wood such as 12 before they are joined or after they are joined. Treatment before joining the strips may have the advantage of easing thorough treatment of the wood throughout its volume. Treatment after joining may, however, be preferred if the treatment interferes with bonding of the strips into boards.

An example of a useful treatment is applying an additive, such as a water repellant, a bulking agent, a wood preservative, or a combination of these or other additives. Other exemplary treatments are cross-linking the wood with multi-functional molecules to form esters or ethers, and bulking the wood with hydrophilic polymers such as polyethylene glycol. Another treatment contemplated to improve dimensional stabilization is impregnation of the wood with acrylic monomers and oligomers, that can then be polymerized in situ to offer dimensional stability and other benefits. Common resins such as phenol-formaldehyde, melamine-formaldehyde, urea-formaldehyde, DMDHEU (dimethyloldihydroxyethyleneurea), or combinations of these can also be introduced into the wood and cured in situ.

The additive may be a water repellant, wood preservative, insecticide, colorant, anti-oxidant, UV-stabilizer, or any combination thereof. The additive may be applied to the wood by using any techniques known in the art. An exemplary application technique is pressure treating. The additive should have sufficient penetration in the wood to achieve the desired degree of water repellency and exterior durability.

The present inventors have discovered that edge-glued vertical-grain boards incorporating a water repellent, have excellent resistance to checking and cracking. The durability of the glue lines, such as 22, is also dramatically improved by the use of water repellents. The inventors theorize as a possible explanation for this improvement that water repellent treated boards absorb water slowly and to a lesser degree than untreated boards. The boards are subject to less stress due to the smaller moisture content fluctuation in the boards. Less stress leads to reduced checking and cracking in the boards. The reduced stress coupled with the lower moisture content make the glue-line much more durable. The inventors do not, however, limit the invention to embodiments consistent with or tending to support this theory.

The water repellent part of the integrated chemical protection system can be based on natural or synthetic wax, silicone, fluoro compounds, or their combinations. The wax can be, for example, the aliphatic or paraffinic petroleum product commonly known as slack wax. Slack wax is the wax recovered from a petroleum hydrocarbon by either solvent or propane dewaxing, and can contain entrained oil in an amount varying up to about 50%, alternatively 35% oil. This is the first waxy material separated in the refining of crude oil. The most preferred water repellent systems are those based on wax emulsions. Natural or synthetic wax emulsions are economical, easily compatible with most preservative systems, and provide good water repellency. The use level of wax-based water repellent can be 0.5-40 kg/m³, preferably 2-20 kg/m³.

The additive composition may also include one or more wood preservatives, also known in the art as fungicides and/or micro-biocides. A wood preservative can provide decay resistance and resistance to mold and stain. The wood preservatives of this invention can be inorganic, organic, or a combination of inorganic and organic materials.

Some particular types of wood preservatives contemplated herein include a copper based preservative system, commercially available as the COMPTEC® copper ammonium acetate complex wood treatment, ACQ® (alkaline copper quat), copper Azole, CCA (chromated copper arsenate), a metal complex of dimethyl glyoxime, copper-HDO, ammoniacal copper complexes, borates, triazoles, isothiazalones, or their combinations.

The wood preservative is preferably present in an amount and form recognized in the industry as effective to preserve the wood and/or in an amount effective to reduce the moisture-induced swelling of the engineered board to less than that of an analogous wood board not treated with the wood stabilizer. “Preservation” is used broadly in this specification to refer to any treatment that reduces the rate of deterioration of a wood board, compared to the rate of deterioration of an analogous wood board lacking the preservative. As discussed in U.S. Pat. No. 6,569,540, the wood preservatives mentioned in this specification can also be used as dimensional stabilizers for wood boards. The use rate of the preservatives depends on the efficacy of the particular preservative system as well as the expected service expectancy of the laminated boards. For example, if ACQ® is the desired fungicide and the boards are to be used in aboveground exterior applications, the current recommended use level is 4 kg of active ACQ® per m³ of wood.

One or more insecticides may be included in the additive to provide resistance to termites and other insects. Examples of insecticides include but are not limited to the pyrethroid family, the nicotinyl family, borates, or the combination thereof. The use level of a particular insecticide system depends on the efficacy as well as exposure conditions.

The additive may also optionally contain colorants, anti-oxidants, UV-stabilizers, or their combinations to enhance the initial appearance of the boards as well as appearance in service.

Optionally, a dimensional stabilizing agent, such as polyethylene glycol, may be included in the additive to further enhance the dimensional stability of the boards.

As another option, the additive may be a finish or protective surface coating, such as a stain, paint, primer, varnish, lacquer, or other coating material. The finish or protective coating can further enhance the appearance and physical performance of the wood. The coating materials may contain, in addition to the ingredients of conventional coating products, extra water repellents, anti-oxidants, UV stabilizers, and micro-biocides.

The various components that may be included in the additive can be formulated into a single concentrate in the form of a solution, emulsion, or suspension. The components can also be formulated individually into component concentrates, which commonly are then diluted to make the treating solution.

The thickness of the engineered wood board 10 can be from 0.1-6 inches (2 to 150 mm), alternatively from 0.5-2 inches (12 to 50 mm), although other dimensions can be used. When relatively thin engineered vertical-grain boards, less than 0.75 inch (19 mm) thick are made, a backing board may be glued to the bottom side of the vertical-grain board to provide additional strength. The backing board may be solid wood, plywood, or other engineered materials. Preferably, the backing board is also treated with the chemical protection system.

FIG. 3 (taken from U.S. Pat. No. 5,135,597) shows one embodiment of a series of process steps resulting in a engineered wood board, and is illustrative of mechanical process steps forming a part of another aspect of the invention. As stated above, there are many variations and modifications of the process illustrated in FIG. 3, which comprise other aspects of the invention.

FIG. 3 shows a conventional log 50, from which a flat grain board 52 is produced by conventional methods in a conventional saw mill. The board 52 shown in FIG. 3 is generally referred to as a side board. Although the dimensions of the side board 52 may vary, depending upon the size of the log 50, for purposes of illustration, the board is shown as a standard 2×6 inch (51 by 150 mm) nominal dimension board. The board 52 is a flat grain board, since its wide dimension or face 54 is approximately parallel with the growth rings or lines 56 in the board. The edge or thickness dimension 58 shows the vertical grain of the board since this dimension is approximately perpendicular to the growth rings 56.

In the next step of the process of the present invention shown in FIG. 3, the flat grain side board 52 is rip sawn for its entire length. In FIG. 3, the board 52 is sawn into five boards 12, 14, 16, 18, and 20, each one of equal thickness. However, the board 52 may be sawn into more or fewer boards, or boards with different thicknesses. It should be noted, for clarification, that the term “rip sawn” herein refers to a longitudinal sawing of the board through the board from top to bottom when the board is oriented so that its wide or face dimensions are the top and bottom. Additionally, the five boards 12, 14, 16, 18, and 20 may be end joined, by means such as finger jointing, to other boards in order to make boards of a desired length.

After the board 52 has been sawn into five separate boards 12, 14, 16, 18, and 20, those boards are then each rotated 90 degrees and edge glued to form a engineered wood board 10. The boards, such as 12, optionally may be green at the time they are edge glued. The basic edge gluing process is well known and is thus not explained in detail here. Prior planing of the boards facilitates the edge gluing step.

The glue for use in all aspects of this invention, if used, can be any weather resistant adhesive, optionally an adhesive that is suitable for exterior applications. Examples of such adhesives include but are not limited to resorcinol-formaldehyde, melamine-formaldehyde, phenol-formaldehyde, phenol-resorcinol-formaldehyde, and isocyanate. UV-stabilizers, anti-oxidants, their combinations, and other additives that could improve the weather resistance and longevity can be included in the adhesives. After the boards 12, 14, 16, 18, and 20 have been edge glued, the resulting board 10 optionally can be sanded or planed, coated, or otherwise treated to provide the finished product.

The engineered wood board 10 optionally can be more stable and can have at least equal strength compared to the original board 52. In the embodiment shown, adjacent boards 12, 14, 16, 18, and 20 are rotated away from each other about their common top and bottom edges 60, 62 alternately across the total number of boards 12, 14, 16, 18, and 20, i.e. successive boards are rotated alternately clockwise and counter-clockwise. While this is advantageous in certain situations, it should be understood that the individual boards may be rotated in a single direction, i.e. all clockwise or all counterclockwise, prior to the step of edge gluing. The invention is not limited to either edge matching technique specifically; rather the boards 12, 14, 16, 18, and 20 may be arranged in various ways relative to each other prior to the step of edge gluing. The boards 12, 14, 16, 18, and 20 may also be derived from non-adjacent portions of a log or different logs.

Although the boards 12, 14, 16, 18, and 20 are disclosed to be glued together, using known glues, it should be understood that the invention includes various gluing techniques as well as other bonding techniques, including techniques designed to create a molecular bond between two adjacent pieces of wood.

Additionally, although not visible from FIG. 3, the process of the invention further comprises treating the wood to improve its water repellency and exterior durability. Such treatment may comprise applying an additive to the wood, or other treatments, such as heat treatment and/or chemical cross-linking. The treatment may be performed at various stages of the board making process. The strips obtained from ripping the flat-sawn boards, either before or after removing any defects, before or after joining the strips, can be treated, dried, and then edge-laminated to produce the vertical-grain boards. Alternatively, the treatment can be applied to the flat-sawn board before ripping or applied to the vertical-grain boards after edge-lamination. Additionally, when an additive is used as the treatment, the additive optionally may be applied when the wood is green.

Certain wood species, known as refractory species in the wood treating industry, are difficult to treat with conventional wood treating practices. For the refractory species, it is preferred that the treatment be applied to the strips before edge-lamination. This is to achieve maximum penetration of the treatment into the wood and thus obtain maximum protection.

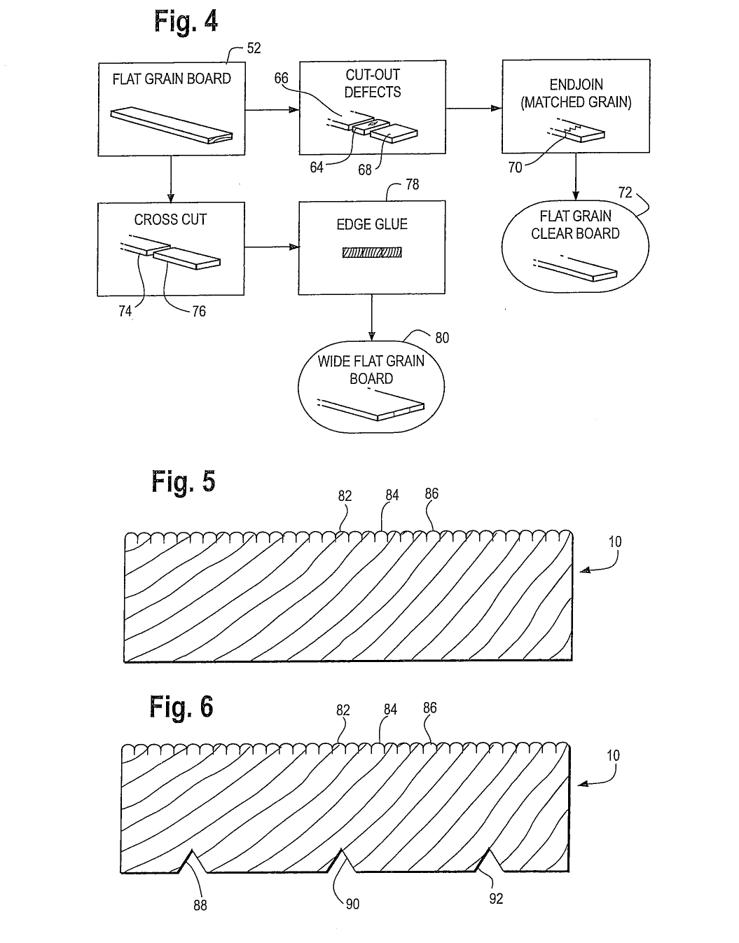

FIG. 4 (taken from U.S. Pat. No. 5,135,597) shows variations of the process of the present invention, beginning with a flat grain board 52 of selected dimensions. The flat grain board 52 can also be an individual strip of wood such as 12. In one variation, the flat grain board 52, instead of being a clear board, has defects, such as knots, therein. In the process shown in FIG. 4, the knots are cut out at 64, by cross-cut sawing, for instance. This results in a plurality of clear boards 66, 68. The cut-out portions can optionally be used for wood chips or other similar products. The boards can then be end joined at 70 to produce a clear flat grain board 72. The clear flat grain board 72 may then be used to produce the vertical grain engineered wood board of the invention. The end joints of the flat grain board 72 optionally can be significantly obscured, i.e. substantially invisible, due to the matching of the grain if the process begins with a single board. The option of finger-jointing the strips is important for a number of reasons. Large defects such as knots, juvenile wood, and reaction wood can be removed and then finger-jointed to form clear strips. Small defects such as wane, small knots, and pith can be finger-jointed in such a way that these minor defects are in the un-exposed side of the vertical-grain strip of an engineered board.

Additional advantages of the boards produced according to the current invention are reduced cupping, warping, crooking, bowing, and twisting compared to solid boards, particularly construction grade lumber.

FIGS. 5 and 6 show variations of the engineered wood board 10 that is illustrative of one aspect of the invention. The engineered wood board 10 of the invention may be machined by sanding, planing, or cutting to produce at least one smooth wide surface. The surfaces of the board may be machined to have slight slopes so that rainwater can run off easily. Optionally, different patterns such as half-round beads 82, 84, 86, grooves 88, 90, 92, or channels can be machined on the laminated board for appearance enhancement or functional purposes. The edges of the board can also be rounded such as in the case of rounded-edge-decking (RED) boards. Half-round beads such as 82 will reduce visible checking on the top surface.

Examples illustrating several applications of the invention are presented below.

### EXAMPLE 1

A flat-sawn Radiata pine 2×6 inch (51 mm by 150 mm) board is planed or sanded on the two wide faces. The board is then ripped into four strips of equal width, the strips are turned 90 degrees, and laminated or joined with a resorcinol-formaldehyde resin into a vertical-grain board. The vertical-grain board is then machined into a round-edge-decking (RED) board. The RED board is then treated in a pressure treating process with a solution containing 0.8% ACQ® and 1.2% of a suitable wax emulsion water repellent. After treating and drying, the board is coated with a commercial semi-transparent stain to obtain the final finished product. The finished product can be used to construct exterior structures such as decks, fences, benches, and picnic tables.

### EXAMPLE 2

A flat-sawn southern yellow pine 2×6 board is ripped into four strips of equal width. Defects in the strips are removed and the short sections finger-jointed with a water resistant two-part cross-linked isocyanate adhesive. The strips are pressure treated with a water-based solution containing 500 PPM Tebuconazole as fungicide, 20 PPM of Imidacloprid as insecticide, and 1.0% wax emulsion as a water repellent. After treating and drying, the tangential faces of the strips are planed to provide fresh and smooth surfaces for gluing with a two-part cross-linked isocyanate adhesive. The laminated vertical-grain board thus obtained is then machined to have a profile shown as FIG. 6. The product obtained according to Example 2 is suitable for decking boards and other exterior applications.

What is claimed is:

1. A engineered wood board having a major face, comprising:
strips of wood oriented with the grain vertical relative to the major face and bonded together side to side; and
an additive composition improving the exterior durability of the wood.

2. The board of claim 1, wherein at least one of the strips of wood is made of at least two strips of wood glued together end to end.

3. The board of claim 1, wherein the additive composition is distributed at least substantially through the thickness of the wood board.

4. The board of claim 1, wherein the additive composition comprises a water repellant.

5. The board of claim 1, wherein the additive composition comprises a material based on natural or synthetic wax, silicone, fluoro compounds, or their combinations.

6. The board of claim 1, wherein the additive composition comprises a wax emulsion.

7. The board of claim 1, wherein the additive composition comprises a material useful as a wood preservative.

8. The board of claim 1, wherein the additive composition comprises alkaline copper quat, chromated copper arsenate, copper Azole, copper-HDO, borates, triazoles, isothiazalones, 3-Iodo-2-propynyl butyl carbamate, or their combinations.

9. The board of claim 1, wherein the additive composition comprises alkaline copper quat.

10. The board of claim 1, wherein the additive composition comprises copper Azole.

11. The board of claim 1, wherein the additive composition comprises copper-HDO.

12. The board of claim 1, wherein the additive composition comprises a borate.

13. The board of claim 1, wherein the additive composition comprises a triazole.

14. The board of claim 1, wherein the additive composition comprises an isothiazalone.

15. The board of claim 1, wherein the additive composition comprises a material useful as an insecticide.

16. The board of claim 1, wherein the additive composition comprises a member of the pyrethroid family, a member of the nicotinyl family, a borate, or their combinations.

17. The board of claim 1, wherein the additive composition comprises a member of the pyrethroid family.

18. The board of claim 1, wherein the additive composition comprises a member of the nicotinyl family.

19. The board of claim 1, wherein the additive composition comprises a material useful as a colorant, an anti-oxidant, a UV-stabilizer, or their combinations.

20. The board of claim 1, wherein the additive composition comprises a material useful as a colorant.

21. The board of claim 1, wherein the additive composition comprises a material useful as an anti-oxidant.

22. The board of claim 1, wherein the additive composition comprises a material useful as a UV-stabilizer.

23. The board of claim 1, wherein the additive composition comprises polyethylene glycol.

26. The board of claim 1, wherein the engineered wood board comprises a protective coating.

27. The board of claim 1, wherein the engineered wood board comprises a finish.

28. The board of claim 27, wherein the finish comprises a stain, paint, varnish, shellac, lacquer, primer, or their combination.

29. A method of manufacturing an engineered wood board having a major face, comprising:
providing strips of wood, the strips having a flat grain surface and a vertical grain surface;
assembling the strips of wood side by side, oriented with the vertical grain surfaces defining a major face of the board;
bonding the strips of wood together; and
treating the wood to improve its exterior durability.

30. The method of claim 29, further comprising, before assembling,
identifying at least one of the strips of wood having a defective portion and a non-defective portion, each running along just part of its length; and
separating the defective portion from the non-defective portion.

31. The method of claim 29, further comprising, before assembling,
identifying at least one of the strips of wood having a defective portion and at least two non-defective portions, each running along just part of its length; and
separating the defective portion from the two non-defective portions.

32. The method of claim 31, further comprising
assembling the two non-defective portions end to end; and
bonding the two non-defective portions together.

33. The method of claim 29, wherein the treatment comprises heat treatment.

34. The method of claim 29, wherein the treatment comprises chemical cross-linking.

35. The method of claim 29, wherein the treatment comprises applying an additive.

36. The method of claim 29, wherein the strips of wood are green at the time of bonding.

37. The method of claim 29, wherein the strips of wood are green when the additive is applied.

38. The board of claim 1 wherein the additive composition comprises a wood stabilizer.

39. The method of claim 29, comprising treating the wood with a water repellant.
